(19) United States
(12) Patent Application Publication
(10) Pub. No.: US 2019/0164154 A1
(43) Pub. Date: May 30, 2019

(54) SYSTEM AND METHOD FOR FACILITATING SECURE TRANSACTIONS

(71) Applicant: Fortune Cookie Consulting, Ltd., Carlsbad, CA (US)

(72) Inventor: David P. Greenberger, Encinitas, CA (US)

(21) Appl. No.: 16/198,006

(22) Filed: Nov. 21, 2018

Related U.S. Application Data
(60) Provisional application No. 62/591,100, filed on Nov. 27, 2017.

(51) Int. Cl. G06Q 20/38; G06Q 20/08

(52) U.S. Cl. CPC G06Q 20/385; G06Q 20/0855

(57) ABSTRACT

Systems and methods for secured electronic transaction execution are described. Embodiments include receiving, from a client device via a communications network, electronic transaction information for a transaction; transmitting, to a device of the third-party agent, a request for a transaction instruction for processing of the transaction by a processing device; receiving, from the device of the third-party agent, the transaction instruction for the transaction; after receipt of the transaction instruction, generating a validation code based at least in part on the transaction instruction; store, in a secured memory location of the secured memory device, the validation code; transmitting, to the client device via the communications network, a request for authenticating the transaction instruction; receive, from the client device, the validation code; and causing transmission of the transaction instruction to the processing device.

### CROSS-REFERENCE TO RELATED APPLICATIONS

This application claims the benefit of U.S. Provisional Patent Application No. 62/591,100, titled SYSTEM AND METHOD FOR FACILITATING SECURE TRANSACTIONS, filed Nov. 27, 2017, which is hereby incorporated by reference herein in its entirety.

### BRIEF DESCRIPTION OF THE DRAWINGS

Embodiments of various inventive features will now be described with reference to the following drawings. Throughout the drawings, reference numbers may be re-used to indicate correspondence between referenced elements. The drawings are provided to illustrate example embodiments described herein and are not intended to limit the scope of the disclosure.

FIG. 1 is a block diagram showing an environment for executing a secure transaction.

FIG. 2 is a process flow diagram showing an example of a method for facilitating a secure transaction.

FIG. 3 is an example user interface with inputs for collecting transaction information.

FIGS. 4A-4C are example user interfaces with inputs for collecting transaction instructions.

FIG. 5 illustrates example instructions generated using the inputs as illustrated in FIGS. 3 and 4A-4C.

### DETAILED DESCRIPTION

Conducting transactions over long distances is just one product of the communications networks across the globe. In conducting such transactions, the parties to the transactions may never be physically present in the same location for the transaction to consummate. However, the transactions may require real world verification of certain aspects of the transaction information or instructions to ensure that the parties are proceeding as intended. Some transactions, such as file transfers or wire transfers, cannot easily be undone once instructions are provided. Therefore, it is desirable to provide a system that facilitates secure and efficient authorization of transactions including third party instructions.

Features are described below to provide such a system. These features include authentication of transaction information between clients and agents, rapid and secure transmission of documents, transmission alerts, safeguarding inputs to ensure the information is not mistakenly or fraudulently changed, and generating verifiable identifiers in transaction instructions.

Various aspects of the novel systems, apparatuses, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of, or combined with, any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different communication technologies, system configurations, networks, and transmission protocols, some of which are illustrated by way of example in the figures and in the following description of the preferred aspects. The detailed description and drawings are merely illustrative of the disclosure rather than limiting, the scope of the disclosure.

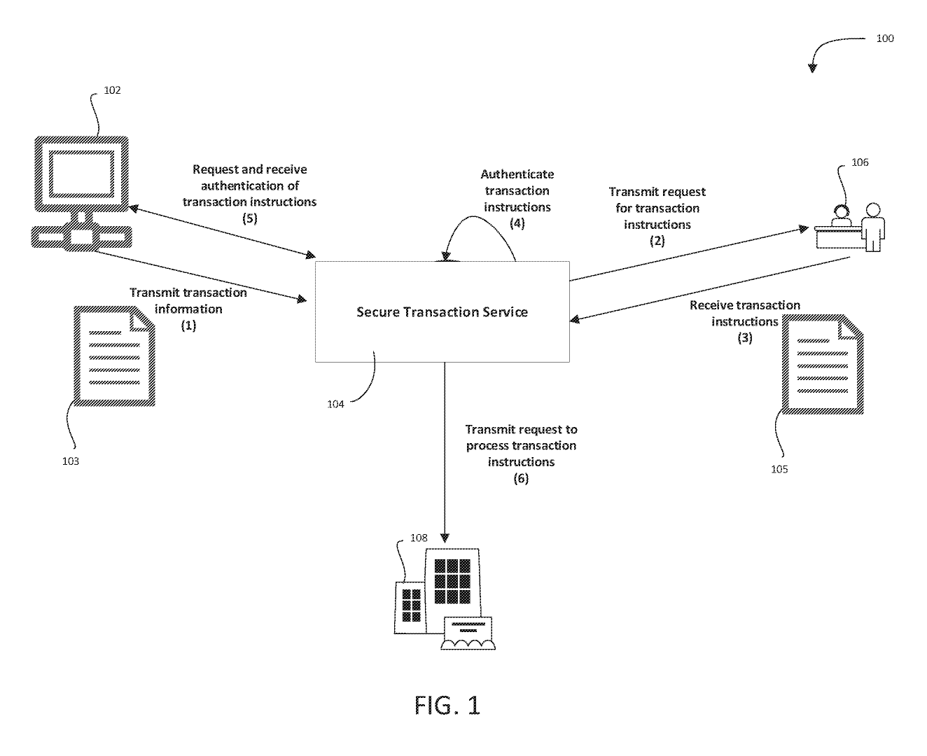

FIG. 1 is a block diagram showing an environment 100 for facilitating and executing a secure transaction. The environment 100 includes several entities which communicate to facilitate a secure transaction between parties. For instance, in some embodiments, the environment 100 includes a client device 102, a service provider 104, an agent device 106, and a transfer agent 108. The client device 102 may receive transaction information 103 such as through a user interface including one or more control elements to receive the transaction information 103. The transaction information 103 generally includes the information needed to identify one or more of: a particular transaction, the subject of the transaction, or the parties included in the transaction. The client device 102 may be any suitable networked device such as a computer, laptop, smartphone, or the like.

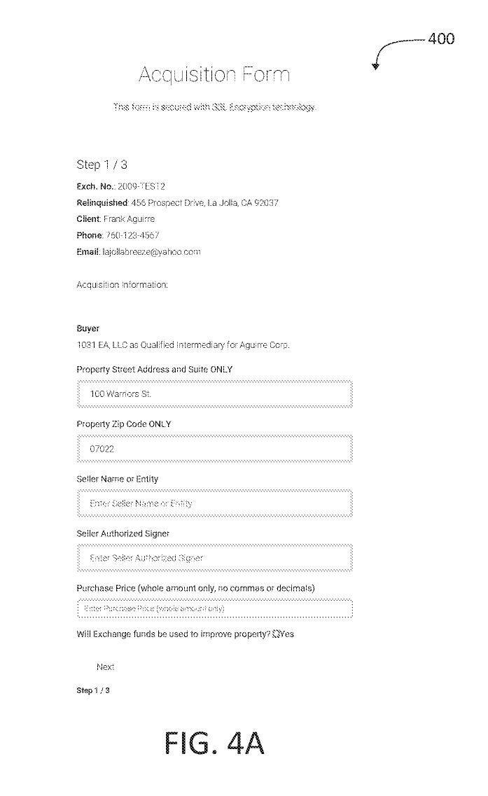

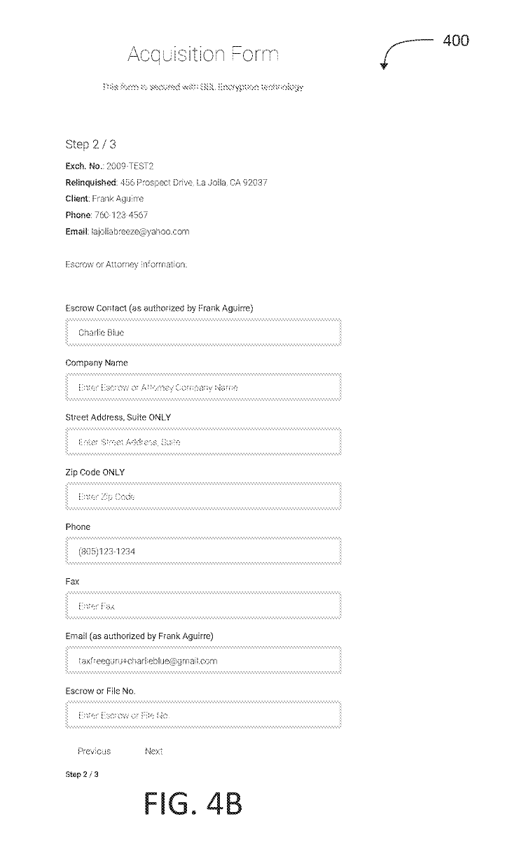

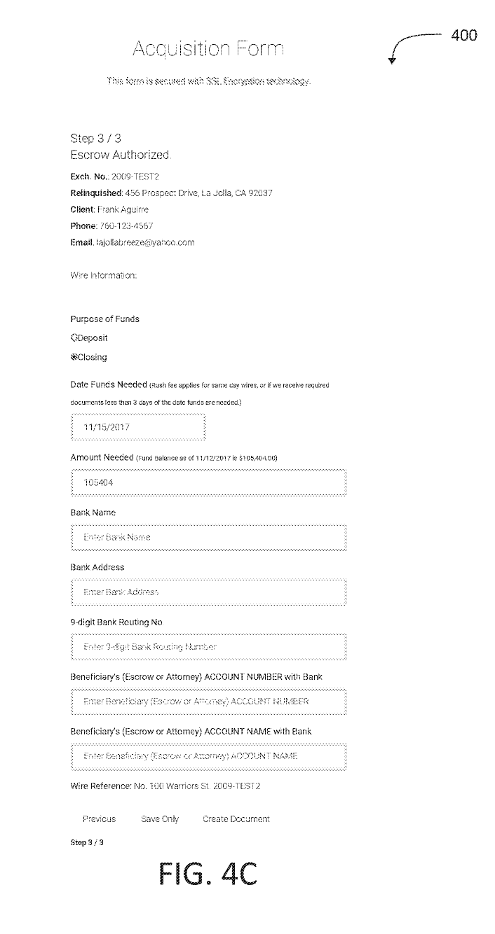

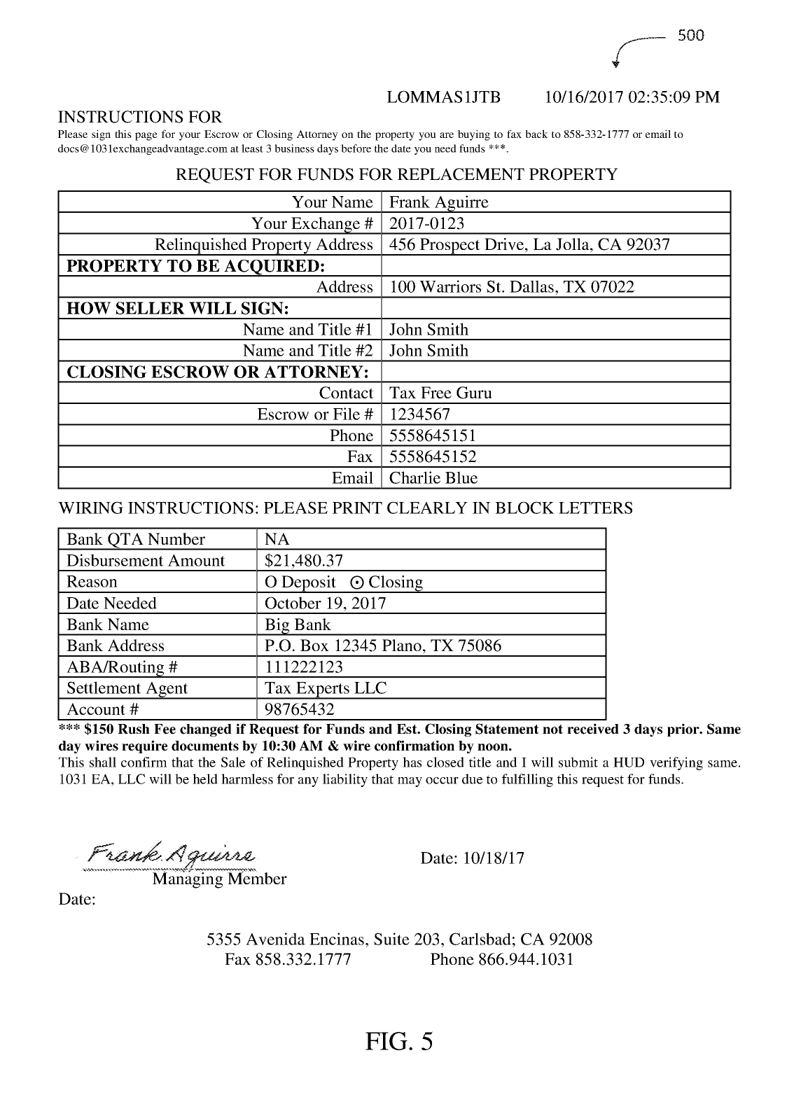

The transaction information 103 inputted by the client may be transmitted to a service provider 104. In response to receiving the transaction information 103, the service provider 104 transmits a request for transaction instructions 105 to an agent device 106. In some embodiments, upon receipt of the transaction information 103, the service provider 104 automatically transmits a request for transaction instructions 105 to an agent identified in the transaction information 103. In some embodiments, the service provider 104 may provide a user interface 400, such as is shown in FIGS. 4A-4C, including one or more control elements for collecting transaction instructions 105. An agent may use the interface presented via the agent device 106 to input transaction instructions and cause transmission of the transaction instructions 105 to the service provider 104. The transaction instructions 105 are then received by the service provider 104. In some embodiments, the service provider 104 may electronically generate a summarized instruction sheet 500, as shown in FIG. 5. The summarized instruction sheet 500 includes information extracted from the transaction information 103 as well as the transaction instructions 105. The transaction instructions 105 may be authenticated by the service provider 104. The service provider 104 may transmit the summarized instruction sheet 500 to the client device 102 for additional verification and authorization by the client. Once the summarized instruction sheet 500 has been verified and authenticated by both the client and the service provider 104, the summarized instruction sheet 500 may then be transmitted to the agent device 106 for additional verification. After the agent has approved the information contained in the summarized instruction sheet 500, the service provider 104 transmits a request to a transfer agent 108 to process the transaction instructions 105. The service provider 104 may include an indicator representing that the transaction instructions 105 have been confirmed by both the client and the service provider 104. The indicator may include a pseudorandomly generated string of characters that are uniquely associated with the transaction. In some embodiments, the summarized instruction sheet 500 generated by the service provider 104 is transmitted to the agent device 106 for additional verification of the information, such as verification of the transaction date and amount. The instruction sheet 500 is shown as a human readable document, but may, in some embodiments, be implemented as a machine readable document. In such embodiments, the machine readable document may include the indicator representing the confirmation of instructions in the document or in metadata associated with the document.

The service provider 104 may include one or more processors. The one or more processors may be implemented with any combination of general-purpose microprocessors, microcontrollers, digital signal processors, or any other suitable entities that can perform calculations or other manipulations of information. The processor may also include memory, which may include both read-only memory and random access memory, may provide instructions and data to the processor. The processor typically performs logical and arithmetic operations based on program instructions stored within the memory. The instructions in the memory may be executable to implement the methods described herein.

The processor may be further configured to communicate with a storage configurable to store information such as transaction information 103, transaction instructions 105, verification and authorization responses received by the service provider 104, verification and authorization indicators for a transaction, or other data supporting the secure transaction methods and systems described. The processor may store information received from providers without modification, in a compressed or encoded form, or results of calculations based on the information. The information may also be stored and separated based on each property or each unit.

The storage may comprise various computer components or recording media that retain information. The storage may include a database, network accessible data storage service, or other information storage file or systems.

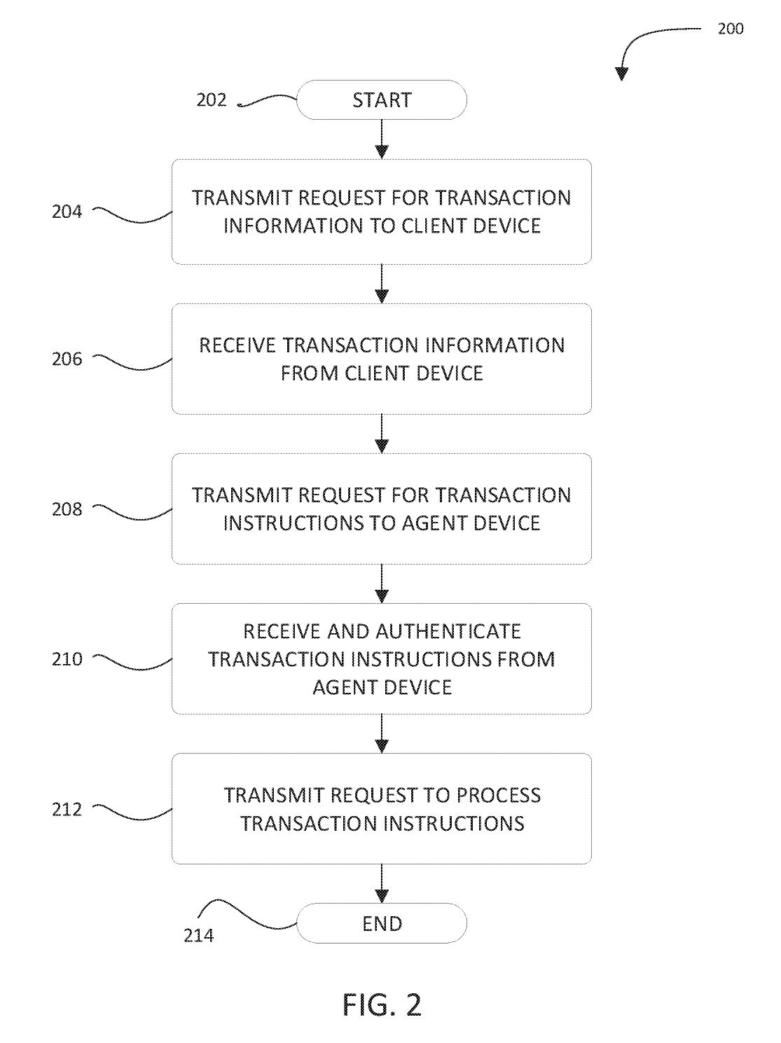

FIG. 2 is a process flow diagram showing an example of a method 200 for facilitating a secure transaction. In some embodiments, the method 200 may be used in a 1031 exchange. Although the method 200 is described below with respect to the elements of 1031 exchanges, those having ordinary skill in the art will appreciate that the steps may be implemented in a variety of transactions and other components may be used to implement one or more of the steps described herein. For example, the features described may be used to facilitate secure transfer of files between networked file systems using an escrow service and a third party transmission service.

At block 204, the service provider 104 may transmit over a network a request for transaction information 103. This may be done in response to the client (buyer/exchanger) registering with the service provider 104. The client may access a user interface 300 including control elements to collect transaction information 103 via the client device 102. The service provider 104 may require that a password or key-phrase is input by the client device 102 before allowing the client device 102 to access the user interface 300 and/or transmit transaction information 103. In some embodiments, the service provider 104 tracks the IP address and/or location of the client device 102 at the time of registration with the service provider 104. Thereafter, in the event the service provider 104 determines that a client's account is being accessed from a different IP address and/or location, the service provider 104 is prompted to perform additional verification (e.g., via phone call or text) of the client before allowing the input or alteration of transaction information 103. In some embodiments, upon detecting a different IP address or location, the service provider 104 automatically transmits an additional verification prompt to the client. Once access has been verified, transaction information 103 can be accessed and/or modified by the client. The transaction information 103 may include information regarding the client's contact information (e.g., email address, home address, telephone number) and/or personal history (e.g., birth date, city of birth, social security number, etc.). Further the transaction information 103 may include information relating to a property which the client wishes to purchase (e.g., address, zip code, etc.) and/or information relating to the property that the client is relinquishing. The transaction information 103 may also include information relating to an escrow service and/or closing agent, such as the agent's name and contact information.

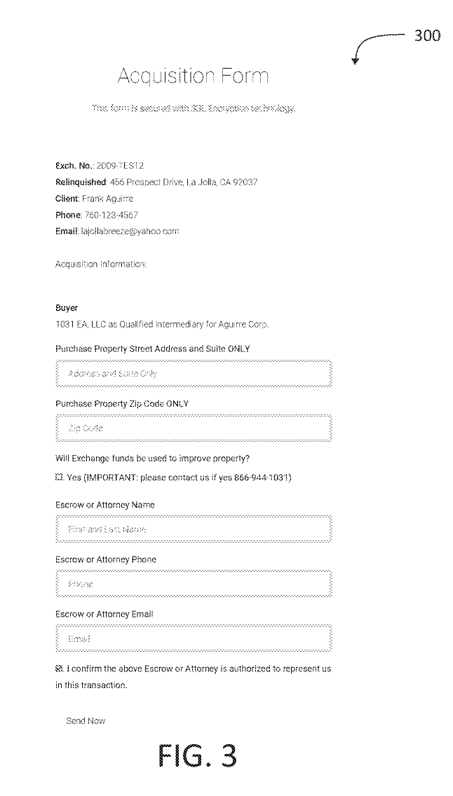

FIG. 3 is an example user interface 300 with inputs for collecting transaction information 103. The user interface 300 shown in FIG. 3 includes control elements such as text boxes, drop down menus, and radio selector to display and edit transaction information. The user interface 300 also includes a control element that, when activated, cause transmission of the information to the service provider. In some implementations, the transmission control elements may be implemented as graphical or textual buttons. In some embodiments, the user interface 300 may be configured to disable alteration of the information entered into the text boxes once the user interface 300 has been completed and transmitted by the client device 102. This reduces the likelihood of the information being unintentionally or fraudulently changed by the agent or the service provider. Further, the user interfaces or data communicated thereby may be secured with SSL encryption technology.

Returning to FIG. 2, at block 206, once the client device 102 inputs and transmits the transaction information 103, the transaction information 103 is received by the service provider 104. The transaction information 103 may be used to identify an agent to receive a message for generating the transaction instructions 105. In some embodiments, the service provider 104 may authenticate the agent identified in the transaction information 103. For instance, the service provider 104 may compare the input agent against a listing of escrow agents to confirm their identity.

At block 208, the service provider 104 transmits a request for transaction instructions 105 to the agent device 106 based on the transaction information 103. The transaction instructions 105 may include information relating to property locations, seller information, purchase price, agent information, and various wire information (e.g., bank name and address, routing number, account information, etc.). The service provider 104 may transmit a notification to the agent device of an agent associated with the transaction instructions 105. The notification may include information to initiate display of a user interface for the agent to review or provide transaction instructions 105.

FIGS. 4A-4C are example user interfaces with inputs for collecting transaction instructions. The user interfaces include control elements such as text boxes, drop down menus, and radio selector to display and edit transaction instructions. The user interfaces also include control elements that, when activated, cause transmission of the information to the service provider. In some implementations, the transmission control elements may be implemented as graphical or textual buttons. The user interface 400 may be configured to disable modification of the user interface 400 once the agent device 106 transmits the user interface 400 to the service provider 104.

Returning to FIG. 2, the agent may review or provide transaction instructions 105 via the user interface presented by the agent device. The user interface may include a control element that, when activated, causes transmission of the transaction instructions 105 to the service provider 104.

At block 210, the service provider 104 receives and authenticates the transaction instructions 105. As part of the authentication, the service provider 104 may electronically generate a summarized instruction sheet 500, as shown in FIG. 5. The summarized instruction sheet 500 includes information extracted from the transaction information 103 as well as the transaction instructions 105. The summarized instruction sheet 500 may be verified and signed by the client prior to transmission to the transfer agent 108. Further, the summarized instruction sheet 500 may include a code or identifier that may be used to securely associate the information contained in the summarized sheet with a particular client account. Additionally, part of the authentication process may include transmitting the transaction instructions 105 to the client device for additional verification.

In some embodiments, once the transaction instructions 105 have been authenticated by the service provider 104, the service provider 104 can transmit a code, such as via a text message, to the client's mobile device. In some implementations the code may be a numeric or alphanumeric code (e.g., a four-digit code). In some implementations, the code may be a graphical code or audio message including a code. The code may be generated based at least in part on a portion of the transaction information. For example, generating the code may include hashing the transaction instructions to generate an intermediate, transaction specific, value which may then be further processed to produce a fixed length code or other confirmation code. Generating the code may be random or pseudorandom based on, for example, time. The city of birth or other demographic information of the client could also be used in generating the code. The service provider 104 may additionally or alternatively transmit a message instructing the client to provide the code to the authorized agent. The agent device 106 will then be prompted to provide the service provider 104 with the code. For example, the service provider 104 can provide a URL link in an email to the agent device 106, instructing the agent to enter into a secured on-line form the valid code, earlier provided to them by the client. Once the agent device 106 provides the service provider 104 with the correct code, the service provider 104 can proceed to request that the transfer agent 108 process the transaction instructions 105 at the date requested. However, an incorrect code entered by agent device 106 will prevent the submission of the transaction instructions 105 to the transfer agent 108.

The code provided to the client via text message may become invalid after a certain amount of time. The duration of time may be a system configuration or dynamically assessed and assigned for specific transactions. For example, if the transaction involves an international participant, the amount of time may be longer than a transaction between participants located in the same state. A new code may be generated and provided to the client after a certain number of failed attempts by the agent to provide the correct code. The number of attempts may be specified in a system configuration or dynamically assessed and assigned for specific transactions. For example, if the transaction is associated with a threshold value (e.g., dollar amount), the number of failed attempts may be lowered in an effort to ensure the security of a high-value transaction where fraud may impose significant losses. In the case where a new code is needed, the service provider 104 can transmit a new code to client upon request such as from the client or an individual authorized by the client.

In some embodiments, providing the client with the text message containing the code can be accomplished by an SMS provider capable of accepting API programming and calls made to its server from subscribers. For instance, an API call can be made from a CRM system of the service provider 104 to the SMS provider in response to the service provider 104 confirming that acquisition documents have been completed. The API can be authenticated using an Account ID and Authorization Token and the API call can be made via a POST XMLHTTPRequest call. The parameters include the SMS provider-assigned phone number for the service provider 104, the mobile number of the client, and the body of the message. A random four-digit code can be generated by a subroutine from the CRM of the service provider 104 and included in the body of the text message sent to client. The four-digit code can be stored in a secured document for access only by the service provider 104 to validate the code thereafter provided by the agent.

In some embodiments, when a secured request for wire confirmation form is opened via the URL link in the email to client device 106, an AJAX (Asynchronous Javascript and XML) call is made to the service provider 104. The service provider 104 may provide one or more values to display that help identify the transaction to be confirmed. For example, the service provider 104 may identify a name to display based on a value included in the AJAX call. The client device 106 may be used to provide one or more inputs to the validation process including the code. The non-code inputs may allow the system to confirm the client device 106 is being used by a user familiar with the transaction. For example, the service provider 104 may request the city associated with a property associated with the transaction. If the input city value does not match the transaction details, the service provider 104 may end the validation process. In such instances, the termination of the validation process avoids transmission of the code increasing the security of the transaction.

On the validation process, the system may not transmit the actual code via the Internet, but only sends a response code such as a Boolean (true or false) value. A true value indicates accept the code entered by the purchase escrow. This causes the system to transmit the wire confirmation information back to the CRM. A false value may cause the display of an invalid code submission message to the purchase escrow via the client device.

In some implementations, the authentication may be dynamic based on the type of transaction. For example, if the transaction is a request for funds for deposit, the client may transmit signed transaction instructions such as via an email with a scanned attachment including their signature. In some implementations, the signature may be digital signature generated using symmetric or asymmetric keys. If transaction is a request for funds for a closing, the client may transmit the signed transaction instructions, and the system may also receive an estimated closing statement from the agent. The authentication may compare information from the client and the agent to ensure the proper instructions for the transaction are to be transmitted. If a discrepancy in amount, date, location, parties, or other transaction information is detected by the system, the transaction may be placed on hold. In some implementations, the system may generate an alert which is transmitted to one or both of the client and the agent regarding the discrepancy and steps to resolve (e.g., resend request, call, provide additional transaction information, etc.).

In some implementations, the authentication may be dynamic based on time. For example, the system may store a time the transaction information is received from the client device. The authentication may then determine an elapsed period of time between receipt of the transaction information and the receipt of the transaction instructions from the agent device. Depending on the elapsed period, different levels of authentication may be applied. Table 1 provides an example of different authentication levels for different periods of time.

TABLE 1

| Elapsed Time | Authentication Protocol |
|---|---|
| One day or less | Single factor authentication based on login |
| | and acknowledgment of transaction |
| | instructions with security token |
| More than one day and | Two-factor authentication based on login and |
| less than one week | acknowledgment of transaction instructions |
| | with security token |
| Over one week | Two-factor authentication based on login and |
| | acknowledgment of transaction instructions |
| | with security token |
| | Telephonic (e.g., interactive voice |
| | recognition) follow up for same |

In some implementations, the authentication may be selectively enabled based on time. For example, one way fraud may be introduced into a transaction may be through transmission of late instructions. In such instances, the parties processing the instructions may not be able to confirm the instructions in sufficient time to meet a transaction deadline. One option is to process the instructions without a full review. However, this is where the fraud may be introduced. The features described allow for a selective process to short-circuit the transaction processing if the instructions are not received in accordance with the desired timing constraints. For example, if an instruction is received within three days of the target completion date of a transaction, the authentication may decline the authentication transaction and refer the transaction to a special handling system. The special handling system may assess each transaction and provide the appropriate messaging to further process the transaction. In some implementations, if correction to the transaction information 103 or the transaction instruction 105 is needed, the correction may be made without the need to void the entire transaction or start anew. The information previously provided by the client and agent may be maintained while only the updated data is replaced. For instance, if the client detects a mistake in the transaction instructions 105, it is not necessary for the client to again submit the transaction information 103. Instead, the service provider 104 may simply allow the agent to input revised transaction instructions 105. In some implementations, the service provider 104 may have already transmitted the instructions with incorrect information. In such scenarios, it may be necessary to replace the transaction documents in their entirety with replacement documentation. The replacement process may include transmitting a cancelation request to the agent or third-party service provider to terminate execution of the original transaction and a new request to effect the new instructions. In some instances, a supplemental transaction may be initiated to effect a difference between the original instructions and the new instructions. For example, if the original instructions requested transfer of four files and the new instructions includes an additional fifth file, a supplemental transaction requesting transfer of only the fifth file may be initiated. The service provider 104 may compare the original instructions to the new instructions to determine whether a supplemental instruction can satisfy the new instructions.

At block 212, after the summarized instruction sheet 500 is verified by the agent, the service provider 104 may automatically transmit the transaction instructions 105 to a transfer agent 108, such as a bank or any financial institution. From the system, the documents received are linked to the particular transaction. Once system authenticates the documents and determines that all documents for the transaction are received, a message (e.g., email) may be transmitted to the agent to advise that the required documents and requesting the agent to finally confirm (or change) the transaction instructions (e.g., amount of wire, date of wire, bank wire information, file transfer date, file transfer location, etc.). If transaction information is changed by the agent, then the method 200 may cancel the current transaction and repeat certain steps to confirm the revised instructions. For example, the system may send a revised request for funds to client for review and signature. If the agent confirms the transaction instructions, a message may be transmitted to both client and the agent indicating the transaction will proceed. On the date requested, the system may transmit the instructions for internal review and approval. The internal review and approval may be performed by the service provider. The review may include confirming the documents, confirming the instructions, and verifying the signatures and authority of the signers. Once confirmed, the service provider may transmit instructions to the third-party transaction service (e.g., bank, file transfer agent, etc.) to effect the transfer.

In establishing a network of transmission alerts and verification by both the client and the agent, the disclosed method may successfully and securely facilitate a transaction, for instance, a 1031 exchange, while reducing the risk of fraud. The method 200 ends at block 214. In some implementations, the method 200 may include receiving a response (e.g., acknowledgement message) from the third party transaction service indicating successful transmission or receipt of the transaction instructions. In such instances, it may be desirable to transmit a confirmation message to one or both of the client and the agent indicating receipt of the instructions.

In some implementations, the service provider 104 may include a secured memory device for storing validation codes. The secured memory device may index the stored codes by identifiers for respective transactions to facilitate efficient look up of a confirmation code for a transaction. One or more processing device included in the service provider 104 may execute instructions stored in a non-transitory computer readable medium. The instructions may cause the service provider 104 to perform the method shown in FIG. 2. For example, the instructions may cause the service provider 104 to receive, from a client device via a communications network, electronic transaction information for a transaction. The electronic transaction information may identify a third-party agent associated with the transaction. The instructions may cause the service provider 104 to transmit, to a device of the third-party agent, a request for a transaction instruction for processing of the transaction by a processing device. The request for the transaction instruction may include at least a portion of the electronic transaction information. The instructions may cause the service provider 104 to receive, from the device of the third-party agent, the transaction instruction for the transaction and, after receipt of the transaction instruction, to generate a validation code based at least in part on the transaction instruction. The instructions may cause the service provider 104 to store, in a secured memory location of the secured memory device, the validation code and to transmit, to the client device via the communications network, a request for authenticating the transaction instruction and to receive, from the client device, the validation code and to cause transmission of the transaction instruction to the processing device.

In some implementations, generating the validation code may include hashing the transaction instruction to generate a hash value and generating the validation code based at least in part on the hash value. Instructions may be included to cause the service provider 104 to transmit a text message including the validation code to the client device, cause the client device to display content hosted by at a network address, initiate an interactive voice recognition telephone call to the client device, or other means of providing or requesting the validation code from the client device. If audio is used to collect a code from a client device, a recording of audio data during the telephone call may be captured for generating a transcript. The validation code may be identified in a portion of the transcript after prompting the user for the validation code.

In some instances, it may be desirable to use graphics rather than alphanumeric codes. In such instances, a library of random images associated with unique words may be provided. A random image may be selected and provided as the validation code to the user who in turn, may be asked to verify the code by speaking or entering the unique word. In this way, the transmission of the validation code does not require directly saying or displaying the validation code. For example, the image presented may show a horse. The validation code in this case would be “horse.” The size of the library of images may be selected based on a level of security needed. In some implementations, a library of at least 10,000 images may provide a sufficient level of security. In some implementations, generating the validation code may include determining that a value in the transaction instructions or the electronic transaction information corresponds to a first threshold associated with a first code generation service; and transmitting a request for the validation code to the first code generation service.

It may be desirable to limit the time during which a validation code may be presented and accepted by the system. In such instances, the service provider 104 may store first temporal information indicating when the validation code was generated; detect second temporal information indicating when the validation code was received from the client device; and determine that a difference between the first temporal information and the second temporal information corresponds to a validity period. The transmission of the transaction instructions may be performed after determining that the different corresponds to the validity period. In this way, an aged validation code may not be accepted thereby increasing the security of the system.

FIG. 5 illustrates example instructions generated using the inputs as illustrated in FIGS. 3 and 4A-4C. The summarized instruction sheet 500 may include the input from the transaction information 103 and the transaction instructions 105 and may reserve a space for approval by the client (e.g., signature line). Further, the summarized instruction sheet 500 may include a code or identifier that may be used to securely associate the information contained in the summarized sheet with a particular client account. The identifier may comprise a first portion that includes pseudoradomly generated characters, such as LOMM-AS1JTB, and a second portion that lists the date and time the summarized instruction sheet 500, such as 10/16/2017 02:35:09 PM. The identifier may be used by the client as an instruction confirmation code. The identifier may also be used internally by the service provider 104. The identifier may be embedded in a file representing the summarized sheet. This ensure the identifier is authentic and verifiable by the service provide 104.

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently, e.g., through multi-threaded processing, interrupt processing, or multiple processors or processor cores or on other parallel architectures, rather than sequentially.

The various illustrative logical blocks, modules, routines, and algorithm steps described in connection with the embodiments disclosed herein can be implemented as electronic hardware, or as a combination of electronic hardware and executable software. To clearly illustrate this interchangeability, various illustrative components, blocks, modules, and steps have been described above generally in terms of their functionality. Whether such functionality is implemented as hardware, or as software that runs on hardware, depends upon the particular application and design constraints imposed on the overall system. The described functionality can be implemented in varying ways for each particular application, but such implementation decisions should not be interpreted as causing a departure from the scope of the disclosure.

Moreover, the various illustrative logical blocks and modules described in connection with the embodiments disclosed herein can be implemented or performed by a machine, such as a service provider server, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A service provider server can be or include a microprocessor, but in the alternative, the service provider server can be or include a controller, microcontroller, or state machine, combinations of the same, or the like configured to generate and publish image processing services backed by a machine learning model. A service provider server can include electrical circuitry configured to process computer-executable instructions. Although described herein primarily with respect to digital technology, a service provider server may also include primarily analog components. For example, some or all of the modeling and service algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a service provider server, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An illustrative storage medium can be coupled to the service provider server such that the service provider server can read information from, and write information to, the storage medium. In the alternative, the storage medium can be integral to the service provider server. The service provider server and the storage medium can reside in an ASIC. The ASIC can reside in a user terminal. In the alternative, the service provider server and the storage medium can reside as discrete components in a user terminal (e.g., access device or agent device).

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

As used herein, the terms “authenticate”, “authenticating”, “verify”, “verifying” and the like encompass a wide variety of actions. For example, “authenticating” may include calculating, computing, processing, deriving, looking up (e.g., looking up in a table, a database or another data structure), ascertaining and the like. Also, “authenticating” may include receiving (e.g., receiving information), accessing (e.g., accessing data in a memory) and the like. Also, “authenticating” may include determining, resolving, selecting, choosing, establishing, and the like.

As used herein, the term “selectively” or “selective” may encompass a wide variety of actions. For example, a “selective” process may include determining one option from multiple options. A “selective” process may include one or more of: dynamically determined inputs, preconfigured inputs, or user-initiated inputs for making the determination. In some embodiments, an n-input switch may be included to provide selective functionality where n is the number of inputs used to make the selection.

As used herein, the terms “transmit”, “transmitting”, “provide”, “providing”, and the like, encompass a wide variety of actions. For example, “transmitting” may include storing a value in a location for subsequent retrieval, providing a value directly to the recipient, providing or storing a reference to a value, and the like. “Transmitting” may also include encoding, decoding, encrypting, decrypting, validating, verifying, and the like.

As used herein, the terms “request” and “message” encompass a wide variety of formats for communicating (e.g., transmitting or receiving) information. A request or a message may include a machine readable aggregation of information such as an XML document, fixed field message, comma separated message, or the like. A request or a message may, in some embodiments, include a signal utilized to transmit one or more representations of the information in textual, graphic, audio, or other perceptible form.

As used herein “receive” or “receiving” may include specific algorithms for obtaining information. For example, receiving may include transmitting a request message for the information. The request message may be transmitted via a network as described above. The request message may be transmitted according to one or more well-defined, machine readable standards which are known in the art. The request message may be stateful in which case the requesting device and the device to which the request was transmitted maintain a state between requests. The request message may be a stateless request in which case the state information for the request is contained within the messages exchanged between the requesting device and the device serving the request. One example of such state information includes a unique token that can be generated by either the requesting or serving device and included in messages exchanged. For example, the response message may include the state information to indicate what request message caused the serving device to transmit the response message.

As used herein “generate” or “generating” may include specific algorithms for creating information based on or using other input information. Generating may include retrieving the input information such as from memory or as provided input parameters to the hardware performing the generating. Once obtained, the generating may include combining the input information. The combination may be performed through specific circuitry configured to provide an output indicating the result of the generating. The combination may be dynamically performed such as through dynamic selection of execution paths based on, for example, the input information, device operational characteristics (e.g., hardware resources available, power level, power source, memory levels, network connectivity, bandwidth, and the like). Generating may also include storing the generated information in a memory location. The memory location may be identified as part of the request message that initiates the generating. In some embodiments, the generating may return location information identifying where the generated information can be accessed. The location information may include a memory location, network locate, file system location, or the like.

As used herein a “user interface” (also referred to as an interactive user interface, a graphical user interface or a UI) may refer to a network based interface including data fields and/or other controls for receiving input signals or providing electronic information and/or for providing information to the user in response to any received input signals. A UI may be implemented in whole or in part using technologies such as hyper-text mark-up language (HTML), FLASH™, JAVA™, .NET™, web services, and rich site summary (RSS). In some embodiments, a UI may be included in a stand-alone client (for example, thick client, fat client) configured to communicate (e.g., send or receive data) in accordance with one or more of the aspects described.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others.

What is claimed is:

1. A system for secured electronic transaction execution, the system comprising:
a secured memory device configured to store validation codes indexed by identifiers for respective transactions;
one or more processing devices; and
a non-transitory computer readable medium storing instructions executable by the one or more processing devices, wherein the instructions, when executed by the one or more processing devices, cause the system to:
receive, from a client device via a communications network, electronic transaction information for a transaction, wherein the electronic transaction information identifies a third-party agent associated with the transaction;
transmit, to a device of the third-party agent, a request for a transaction instruction for processing of the transaction by a processing device, wherein the request for the transaction instruction includes at least a portion of the electronic transaction information;
receive, from the device of the third-party agent, the transaction instruction for the transaction;
after receipt of the transaction instruction, generate a validation code based at least in part on the transaction instruction;
store, in a secured memory location of the secured memory device, the validation code;
transmit, to the client device via the communications network, a request for authenticating the transaction instruction;
receive, from the client device, the validation code; and
cause transmission of the transaction instruction to the processing device.

2. The system of claim 1, wherein generating the validation code comprises:
hashing the transaction instruction to generate a hash value; and
generating the validation code based at least in part on the hash value.

3. The system of claim 1, wherein the instructions, when executed by the one or more processing devices, further cause the system to transmit a text message including the validation code to the client device.

4. The system of claim 1, wherein the request includes a network address, and wherein the request causes the client device to display content hosted by the network address, the content including at least one control element for receiving an input value.

5. The system of claim 1, wherein transmitting the request comprises initiating a telephone call to the client device, and wherein receiving the validation code comprises:
recording audio data during the telephone call;
generating a transcript of the audio data; and
identifying the validation code in a portion of the transcript after a predetermined question requesting the validation code is asked.

6. The system of claim 1, wherein generating the validation code comprises:
storing a library of at least 10,000 validation images in association with unique codes;
storing a unique word for each of the 10,000 validation images;
generating a pseudorandom number; and
selecting, from the library of validation images, an image corresponding to the pseudorandom number, wherein the validation code is the unique word associated with the image.

7. The system of claim 1, wherein generating the validation code comprises:
determining that a value in the transaction instructions or the electronic transaction information corresponds to a first threshold associated with a first code generation service; and
transmitting a request for the validation code to the first code generation service.

8. The system of claim 1, wherein the instructions, when executed by the one or more processing devices, further cause the system to:
store first temporal information indicating when the validation code was generated;
detect second temporal information indicating when the validation code was received from the client device; and
determine that a difference between the first temporal information and the second temporal information corresponds to a validity period, wherein causing transmission of the transaction instructions is performed after determining that the different corresponds to the validity period.

9. The system of claim 1, wherein the instructions, when executed by the one or more processing devices, further cause the system to:
upon receiving the transaction instructions, generate an instruction code for the instructions; and
embed the instruction code into a file representing the transaction instructions.

10. The system of claim 1, wherein the instructions, when executed by the one or more processing devices, further cause the system to:
determine that the transaction instruction was received by the processing system based at least in part on an acknowledgement message received from the processing system; and
transmit a message to the client device indicating successful transmission of the transaction instruction.

11. A method for executing secured electronic transactions, the method comprising:
storing, in a secured memory device, validation codes indexed by identifiers for respective transactions; and
storing, in a non-transitory computer readable medium, instructions executable by one or more processing devices, wherein the instructions, when executed by the one or more processing devices, cause the system to:
receive, from a client device via a communications network, electronic transaction information for a transaction, wherein the electronic transaction information identifies a third-party agent associated with the transaction;
transmit, to a device of the third-party agent, a request for a transaction instruction for processing of the transaction by a processing device, wherein the request for the transaction instruction includes at least a portion of the electronic transaction information;
receive, from the device of the third-party agent, the transaction instruction for the transaction;
after receipt of the transaction instruction, generate a validation code based at least in part on the transaction instruction;
store, in a secured memory location of the secured memory device, the validation code;
transmit, to the client device via the communications network, a request for authenticating the transaction instruction;
receive, from the client device, the validation code; and
cause transmission of the transaction instruction to the processing device.

12. The method of claim 11, wherein generating the validation code comprises:
hashing the transaction instruction to generate a hash value; and
generating the validation code based at least in part on the hash value.

13. The method of claim 11, wherein the instructions, when executed by the one or more processing devices, further cause the system to transmit a text message including the validation code to the client device.

14. The method of claim 11, wherein the request includes a network address, and wherein the request causes the client device to display content hosted by the network address, the content including at least one control element for receiving an input value.

15. The method of claim 11, wherein transmitting the request comprises initiating a telephone call to the client device, and wherein receiving the validation code comprises:
recording audio data during the telephone call;
generating a transcript of the audio data; and
identifying the validation code in a portion of the transcript after a predetermined question requesting the validation code is asked.

16. The method of claim 11, wherein generating the validation code comprises:
storing a library of at least 10,000 validation images in association with unique codes;
storing a unique word for each of the 10,000 validation images;
generating a pseudorandom number; and
selecting, from the library of validation images, an image corresponding to the pseudorandom number, wherein the validation code is the unique word associated with the image.

17. The method of claim 11, wherein generating the validation code comprises:
determining that a value in the transaction instructions or the electronic transaction information corresponds to a first threshold associated with a first code generation service; and
transmitting a request for the validation code to the first code generation service.

18. The method of claim 11, wherein the instructions, when executed by the one or more processing devices, further cause the system to:
store first temporal information indicating when the validation code was generated;
detect second temporal information indicating when the validation code was received from the client device; and
determine that a difference between the first temporal information and the second temporal information corresponds to a validity period, wherein causing transmission of the transaction instructions is performed after determining that the different corresponds to the validity period.

19. The method of claim 11, wherein the instructions, when executed by the one or more processing devices, further cause the system to:
upon receiving the transaction instructions, generate an instruction code for the instructions; and
embed the instruction code into a file representing the transaction instructions.

20. The method of claim 11, wherein the instructions, when executed by the one or more processing devices, further cause the system to:
determine that the transaction instruction was received by the processing system based at least in part on an acknowledgement message received from the processing system; and
transmit a message to the client device indicating successful transmission of the transaction instruction.
